(19) United States
(12) Patent Application Publication
(10) Pub. No.: US 2025/0131891 A1
(43) Pub. Date: Apr. 24, 2025

(54) DISPLAY DEVICE

(71) Applicant: Panasonic Automotive Systems Co., Ltd., Kanagawa (JP)

(72) Inventor: Hiroaki SATO, Kanagawa (JP)

(73) Assignee: Panasonic Automotive Systems Co., Ltd., Kanagawa (JP)

(21) Appl. No.: 19/000,104

(22) Filed: Dec. 23, 2024

Related U.S. Application Data
(63) Continuation of application No. PCT/JP2023/011584, filed on Mar. 23, 2023.

(30) Foreign Application Priority Data
Jun. 27, 2022 (JP) 2022-102789

(51) Int. Cl. G09G 3/34

(52) U.S. Cl. CPC G09G 3/3426; G09G 2330/021; G09G 2360/144

(57) ABSTRACT

In a display device, a display panel displays a first image in a first image region in a display region. An illuminance sensor detects illuminance of incident light. The backlight includes multiple light sources arranged in a matrix. The plurality of light sources include a first light source group constituted by at least one light source that overlaps the first image region, and a first peripheral light source group constituted by at least one light source located on the periphery of the first light source group. The control circuit allows the backlight to turn on the first light source group when the illuminance is less than a first threshold. The control circuit allows the backlight to turn on the first light source group and at least one light source of the first peripheral light source group, when the illuminance is greater than or equal to the first threshold.

### BACKGROUND

### 1. Field

The present disclosure relates to a display device.

### 2. Description of the Related Art

A video display device that controls the luminance of an LED backlight according to ambient illuminance is known (see Patent Literature 1, for example).
Patent Literature 1: Japanese Unexamined Patent Application Publication No. 2013-37015

### SUMMARY

For display devices, further improvement has been required.

To solve the problem above, a display device according to one embodiment of the present disclosure includes: a display panel that displays a first image in a first image region in a display region; a backlight that is located behind the display panel and illuminates the display panel; an illuminance sensor that detects illuminance of incident light; and a control circuit that controls the backlight based on the illuminance. The backlight includes multiple light sources arranged in a matrix. The multiple light sources include a first light source group constituted by at least one light source that overlaps the first image region when observed from a normal direction of the display panel, and a first peripheral light source group constituted by at least one light source located on the periphery of the first light source group. The control circuit allows the backlight to turn on the first light source group when the illuminance is less than a first threshold, which is a predetermined value. The control circuit allows the backlight to turn on the first light source group and at least one light source of the first peripheral light source group, when the illuminance is greater than or equal to the first threshold.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram that illustrates a configuration of a display device according to a first embodiment;

FIG. 2 is a diagram that shows relationships between the illuminance of incident light and the luminance of a first image region in the display device shown in FIG. 1;

FIG. 3 is a diagram that shows a lighting state of a backlight shown in FIG. 1 when the illuminance of incident light is less than a first threshold;

FIG. 4 is a diagram that shows a lighting state of the backlight shown in FIG. 1 when the illuminance of incident light is greater than or equal to the first threshold and less than a second threshold;

FIG. 5 is a diagram that shows a lighting state of the backlight shown in FIG. 1 when the illuminance of incident light is greater than or equal to the second threshold and less than a third threshold;

FIG. 6 is a diagram that shows a lighting state of the backlight when the illuminance of incident light is greater than or equal to the third threshold;

FIG. 7 is a diagram that shows relationships between the illuminance of incident light and the luminance of the first image region in a display device according to a second embodiment;

FIG. 8 is a diagram that shows a lighting state of the backlight, with multiple images superimposed thereon, when the illuminance of incident light is less than the first threshold in the second embodiment;

FIG. 9 is a diagram that shows a lighting state of the backlight, with multiple images superimposed thereon, when the illuminance of incident light is greater than or equal to the first threshold and less than the second threshold in the second embodiment;

FIG. 10 is a diagram that shows a lighting state of the backlight, with multiple images superimposed thereon, when the illuminance of incident light is greater than or equal to the second threshold in the second embodiment;

FIG. 11 is a diagram that shows a lighting state of the backlight, with multiple images superimposed thereon, when the illuminance of incident light is less than the first threshold in a third embodiment;

FIG. 12 is a diagram that shows a lighting state of the backlight, with multiple images superimposed thereon, when the illuminance of incident light is greater than or equal to the first threshold and less than the second threshold in the third embodiment;

FIG. 13 is a diagram that shows a lighting state of the backlight, with multiple images superimposed thereon, when the illuminance of incident light is greater than or equal to the first threshold and less than the second threshold in a modification of the third embodiment;

FIG. 14 is a diagram that shows a lighting state of the backlight, with multiple images superimposed thereon, when the illuminance of incident light is less than the first threshold in a fourth embodiment;

FIG. 15 is a diagram that shows a lighting state of the backlight, with multiple images superimposed thereon, when the illuminance of incident light is greater than or equal to the first threshold and less than the second threshold in the fourth embodiment; and

FIG. 16 is a flowchart that shows an example of processing for determining control performed by a control circuit shown in FIG. 1.

### DETAILED DESCRIPTION

The invention will now be described by reference to the preferred embodiments. This does not intend to limit the scope of the present invention, but to exemplify the invention.

### Base Findings of Present Disclosure

Before specific description of an embodiment is given, the underlying findings will be described. In a display device equipped with a display panel for displaying an image and with a backlight including multiple light sources for illuminating the display panel, when the illuminance of outside light is high, the luminance of a light source overlapping an image is increased to display the image brighter, thereby enhancing the visibility of the image.

However, the inventor has discovered that there is a limit to the increase in the brightness of the image by increasing the luminance of a light source overlapping the image. To solve the problem, a display device according to the present disclosure is configured as described below.

Like reference characters denote like or corresponding constituting elements, members, and processes in each drawing, and repetitive description will be omitted as appropriate. Also, the dimensions of a member may be appropriately enlarged or reduced in each drawing in order to facilitate understanding.

### First Embodiment

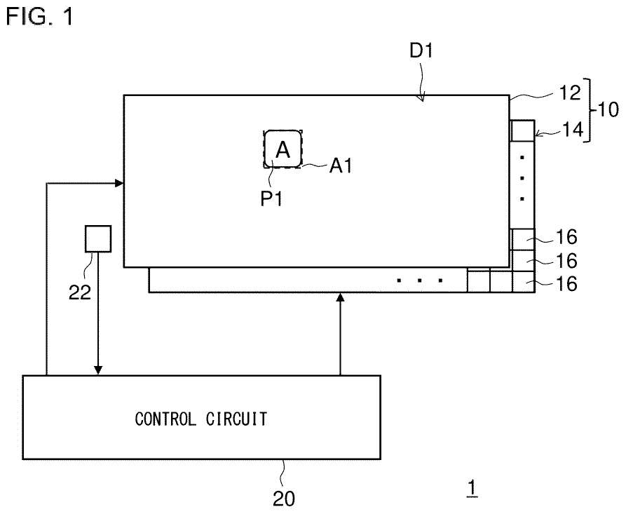

FIG. 1 illustrates a configuration of a display device 1 according to the first embodiment. Although an example will be described in which the display device 1 is a vehicle-mounted display device, the application of the display device 1 is not particularly limited. For example, the display device 1 may be a display device of a portable electronic device or a display device of a stationary electronic device.

The display device 1 may be installed, for example, near the center of the center console in a vehicle cabin. The display device 1 displays various information. There is a case where outside light, which is sunlight, enters the display surface of the display device 1 through a vehicle window, and the outside light is specularly reflected on the display surface and directed to the driver's eyes. In this case, the driver may have difficulty visually recognizing the content displayed on the display device 1. Accordingly, the display device 1 detects the illuminance near the display surface and increases the screen luminance as the illuminance thus detected is greater. This can improve the visibility of the display device 1 when the illuminance of the incident light is high.

The display device 1 includes a display unit 10, a control circuit 20, and an illuminance sensor 22. The display unit 10 includes a display panel 12 and a backlight 14.

The display panel 12 is a liquid crystal panel. The display panel 12 displays at least one image in a display region D1. In the illustrated example, the display panel 12 displays a first image P1, which shows a figure showing a letter “A”, in a first image region A1, which is part of the display region D1, and displays no other images. The first image region A1 is rectangular, for example. When the first image P1 shows a single figure, as in the illustrated example, the first image region A1 may be a region having substantially the same outer shape as the first image P1. When the first image P1 is a set of multiple images, the first image region A1 may be a region that contains the multiple images. When the first image P1 shows one or more characters, the first image region A1 may be a region that contains the one or more characters.

The backlight 14 is a direct backlight. The backlight 14 is located behind the display panel 12 and illuminates the display panel 12. The backlight 14 includes multiple light sources 16 that illuminate the display panel 12. In each of the multiple light sources 16, a light emitting diode (LED), not illustrated, is disposed. The multiple light sources 16 are arranged in a matrix, for example. Each light source 16 constitutes a light-emitting region. The multiple light sources 16 need not necessarily be arranged regularly and may be arranged irregularly based on the shape or the display content of the display panel 12. The luminance of each light source 16 can be controlled individually.

The control circuit 20 displays an image on the display panel 12 via a liquid crystal drive circuit, which is not illustrated. The control circuit 20 controls the backlight 14 via a light source drive circuit, which is not illustrated, and controls the luminance of each light source 16. The control circuit 20 varies the luminance of each light source 16 based on the image displayed on the display panel 12. Such control is called local dimming. This can reduce power consumption and improve image contrast.

The illuminance sensor 22 detects the illuminance of the incident light onto the display device 1 and outputs a signal indicating the illuminance thus detected to the control circuit 20. Viewed from the viewer's side, the illuminance sensor 22 is disposed next to the display panel 12. This enables detection of illuminance close to that of outside light incident on the display panel 12. The control circuit 20 controls the backlight 14 based on the illuminance detected by the illuminance sensor 22.

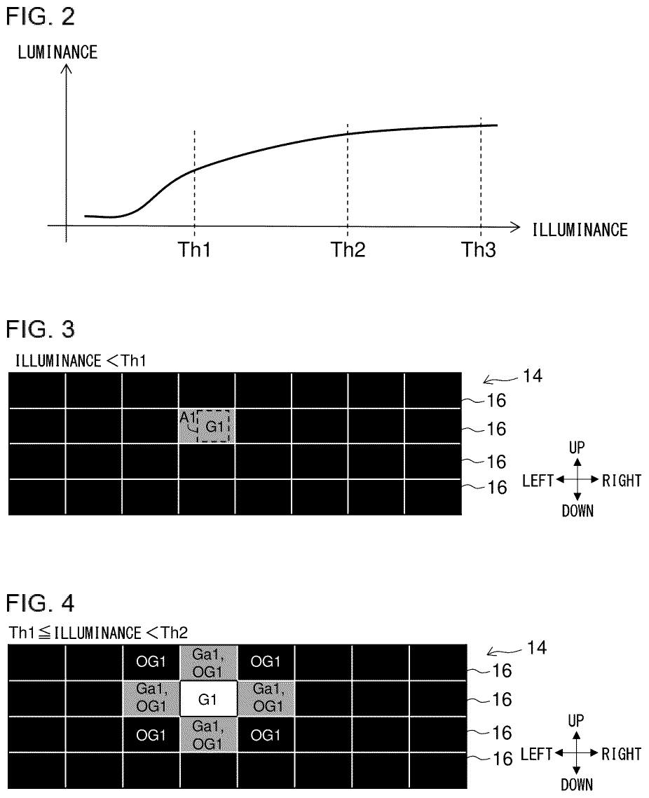

FIG. 2 shows relationships between the illuminance of incident light and the luminance of the first image region A1 in the display device 1 shown in FIG. 1. In FIG. 2, a first threshold Th1, a second threshold Th2, and a third threshold Th3, which each are a predetermined value, are shown as thresholds for illuminance. These thresholds can be appropriately determined through experiments or simulations.

FIG. 3 shows a lighting state of the backlight 14 when the illuminance of the incident light is less than the first threshold Th1. FIG. 3 and other figures showing a lighting state of the backlight 14 are diagrams viewed from a normal direction of the display panel 12 on the viewer's side.

The multiple light sources 16 include a first light source group G1, which is constituted by at least one light source 16 that overlaps the first image region A1 when observed from the normal direction of the display panel 12. When the illuminance is less than the first threshold Th1, the control circuit 20 allows the backlight 14 to turn on the first light source group G1. In other words, each light source 16 constituting the first light source group G1 at least partially overlaps the first image region A1. It is assumed here that the entirety of one light source 16 overlaps the first image region A1, while the other multiple light sources 16 do not overlap the first image region A1.

As in an example described later, depending on the size of the first image P1, i.e., the size of the first image region A1, multiple light sources 16 may overlap the first image region A1. In this case, the first light source group G1 is constituted by the multiple light sources 16 overlapping the first image region A1. A “light source group” represents one or more light sources 16.

When the illuminance is less than the first threshold Th1, the control circuit 20 allows the backlight 14 to turn on the first light source group G1 at a luminance that is higher as the illuminance is greater and that is less than a predetermined luminance. The predetermined luminance is the maximum settable luminance for one light source 16 and may be, for example, the luminance when the rated current is applied. Hereinafter, lighting a light source 16 at a luminance less than the predetermined luminance may be referred to as dimming lighting. The control circuit 20 allows the backlight 14 to perform dimming lighting of the first light source group G1 based on the illuminance. When the illuminance is less than the first threshold Th1, the control circuit 20 allows the backlight 14 to turn off the light sources 16 other than the first light source group G1.

In each diagram showing a lighting state of the backlight 14, black indicates an unlit state, and a color closer to white with respect to the black indicates a higher luminance. Also, in the diagrams that each show a lighting state of the backlight 14, the number of light sources 16 may be set to “32” as an example but is not limited to “32”.

FIG. 4 shows a lighting state of the backlight 14 when the illuminance of the incident light is greater than or equal to the first threshold Th1 and less than the second threshold Th2. In FIG. 4 to FIG. 6, the illustration of the first image region A1 is omitted.

The multiple light sources 16 further include a first peripheral light source group OG1 constituted by at least one light source 16 located on the periphery of the first light source group G1. The first peripheral light source group OG1 includes a first group Gal constituted by at least one light source 16. The first group Gal is part of the first peripheral light source group OG1. When the illuminance is greater than or equal to the first threshold Th1 and less than the second threshold Th2, the control circuit 20 allows the backlight 14 to turn on the first light source group G1 and the first group Gal. The first peripheral light source group OG1 is constituted by the eight light sources 16 located on the periphery of the first light source group G1.

In the example of FIG. 4, the first group Gal is constituted by the two light sources 16 located adjacent, on the left and right, to the light source 16 of the first light source group G1, and the two light sources 16 located adjacent, above and below, to the light source 16 of the first light source group G1. Which light source 16 of the first peripheral light source group OG1 to be set as the first group Gal can be determined as appropriate. The first group Gal is also constituted by one or more light sources 16.

When the illuminance is greater than or equal to the first threshold Th1, the control circuit 20 allows the backlight 14 to turn on the first light source group G1 at the predetermined luminance and turn on the first group Gal at a luminance that is higher as the illuminance is greater.

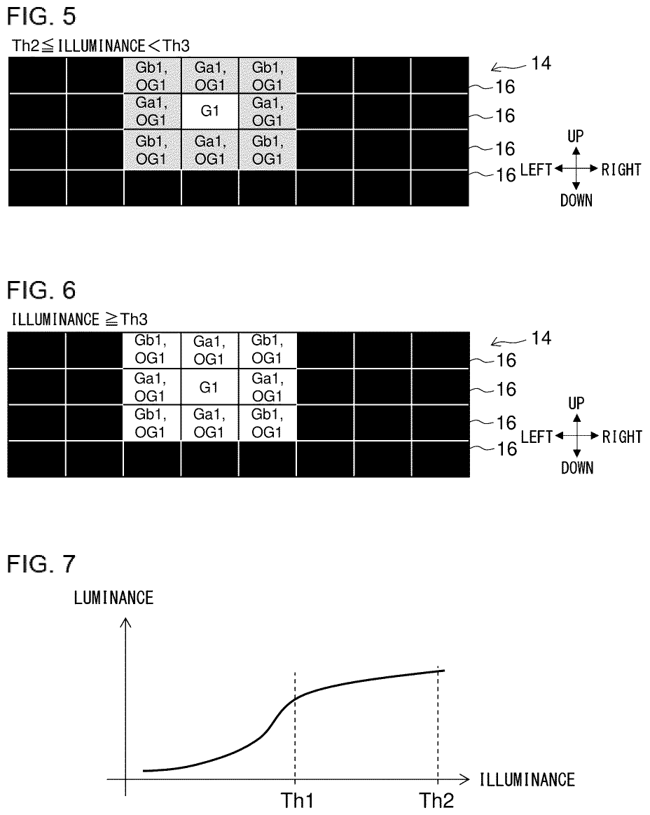

FIG. 5 shows a lighting state of the backlight 14 shown in FIG. 1 when the illuminance of the incident light is greater than or equal to the second threshold Th2 and less than the third threshold Th3.

The first peripheral light source group OG1 further includes a second group Gb1 that is different from the first group Gal and constituted by at least one light source 16. The second group Gb1 is also part of the first peripheral light source group OG1. When the illuminance is greater than or equal to the second threshold Th2, the control circuit 20 allows the backlight 14 to turn on the first light source group G1, the first group Gal, and the second group Gb1.

In the example of FIG. 5, the second group Gb1 is constituted by the four light sources 16 located diagonally adjacent to the light source 16 of the first light source group G1. That is, all of the first peripheral light source group OG1 are turned on. Which light source 16 of the first peripheral light source group OG1 to be set as the second group Gb1 can be determined as appropriate. The second group Gb1 is also constituted by one or more light sources 16. When the illuminance is greater than or equal to the second threshold Th2, only part of the first peripheral light source group OG1 may be turned on.

When the illuminance is greater than or equal to the second threshold Th2, the control circuit 20 allows the backlight 14 to turn on the first group Gal and the second group Gb1 at a luminance that is higher as the illuminance is greater. In the example of FIG. 5, the luminance of the first group Gal is equal to the luminance of the second group Gb1. The luminance of the first group Gal is equal to the luminance of the second group Gb1 also when the illuminance is equal to the second threshold Th2. However, the luminance of the first group Gal and the luminance of the second group Gb1 may be different and may be appropriately determined so that the relationship between the illuminance of the incident light and the luminance of the first image region A1 becomes a desired relationship.

FIG. 6 shows a lighting state of the backlight 14 when the illuminance of incident light is greater than or equal to the third threshold Th3. When the illuminance is greater than or equal to the third threshold Th3, the control circuit 20 allows the backlight 14 to turn on each of the first light source group G1, the first group Gal, and the second group Gb1, at the predetermined luminance.

Thus, when the illuminance is greater than or equal to the first threshold Th1, the control circuit 20 allows the backlight 14 to turn on the first light source group G1 and at least one light source 16 of the first peripheral light source group OG1. Also, when the illuminance is greater than or equal to the first threshold Th1, the control circuit 20 allows the backlight 14 to turn on at least one light source 16 of the first peripheral light source group OG1 at a luminance that is higher as the illuminance is greater.

When multiple images are displayed on the display panel 12, the control circuit 20 performs the control described above for each image.

As described above, when the illuminance is greater than or equal to the first threshold Th1, a light source 16 located around the first light source group G1 is also turned on, in addition to the first light source group G1 overlapping the first image region A1. Accordingly, compared to the case where only the first light source group G1 is turned on, the luminance of the first image region A1 can be increased. Therefore, even when relatively strong outside light, such as sunlight, enters the display region D1, degradation of image visibility can be suppressed.

Also, when the illuminance is less than the first threshold Th1, dimming lighting of the first light source group G1 is performed based on the illuminance. When the illuminance is greater than or equal to the first threshold Th1, dimming lighting of the first group Gal is performed based on the illuminance. When the illuminance is greater than or equal to the second threshold Th2, dimming lighting of the first group Gal and the second group Gb1 is performed based on the illuminance. Therefore, the luminance of the first image region A1 can be varied smoothly based on the illuminance.

In the above example, three thresholds are used as the thresholds for illuminance. However, the number of thresholds is not limited to three and may be one, two, or four or more. The number of thresholds may be appropriately determined so that the relationship between the illuminance of the incident light and the luminance of the first image region A1 becomes a desired relationship.

For example, when one threshold of the first threshold Th1 is used, the control circuit 20 may allow the backlight 14 to turn on the first light source group G1 at the maximum luminance when the illuminance is less than the first threshold Th1 and may allow the backlight 14 to turn on each of the first light source group G1 and at least one light source 16 of the first peripheral light source group OG1 at the maximum luminance when the illuminance is greater than or equal to the first threshold Th1. This case can simplify the control.

When two thresholds of the first threshold Th1 and the second threshold Th2 are used and when the illuminance is less than the first threshold Th1, the control circuit 20 may allow the backlight 14 to perform dimming lighting of the first light source group G1 based on the illuminance. When the illuminance is greater than or equal to the first threshold Th1 and less than the second threshold Th2, the control circuit 20 may allow the backlight 14 to perform dimming lighting of the first light source group G1 and at least one light source 16 of the first peripheral light source group OG1 based on the illuminance. When the illuminance is greater than or equal to the second threshold Th2, the control circuit 20 may allow the backlight 14 to turn on the first light source group G1 and at least one light source 16 of the first peripheral light source group OG1, at the maximum luminance. This case can also simplify the control.

### Second Embodiment

The second embodiment differs from the first embodiment in that, when the illuminance is greater than or equal to the first threshold Th1 and when there are two image regions in proximity to each other, a light source 16 that overlaps a region between the two image regions in proximity is turned on. In the following, description will be given mainly for the differences from the first embodiment.

FIG. 7 shows relationships between the illuminance of incident light and the luminance of the first image region A1 in the display device 1 according to the second embodiment. As the thresholds for illuminance, the first threshold Th1 and the second threshold Th2 are used.

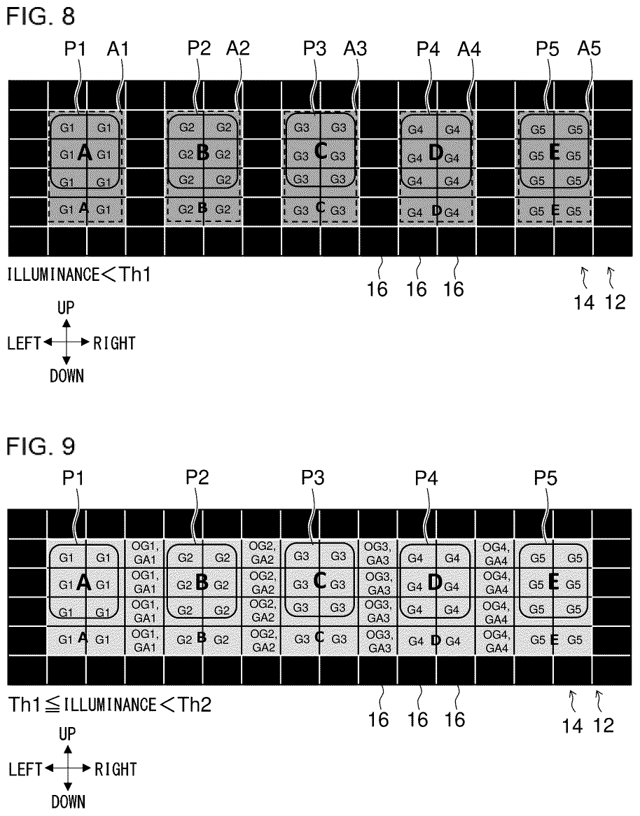

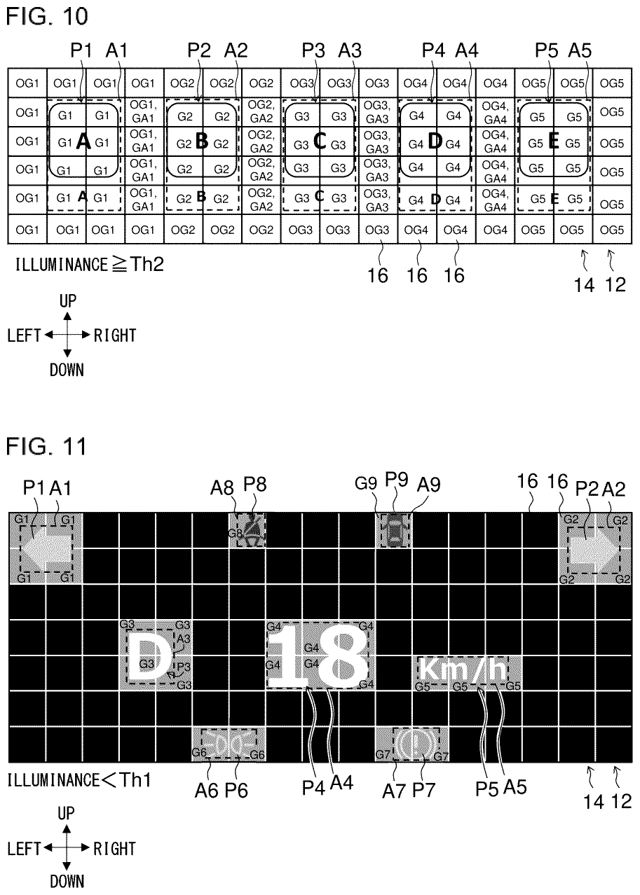

FIG. 8 shows a lighting state of the backlight 14, with multiple images superimposed thereon, when the illuminance of the incident light is less than the first threshold Th1 in the second embodiment. In FIG. 8 and also in FIG. 9 and FIG. 10 described later, the number of light sources 16 is set to “96” as an example but is not limited to “96”.

The display panel 12 displays a first image P1 in the first image region A1, a second image P2 in a second image region A2, a third image P3 in a third image region A3, a fourth image P4 in a fourth image region A4, and a fifth image P5 in a fifth image region A5.

The first image P1 includes a figure showing a letter “A”, and a letter “A” shown below the figure. The second image P2 includes a figure showing a letter “B”, and a letter “B” shown below the figure. The third image P3 includes a figure showing a letter “C”, and a letter “C” shown below the figure. The fourth image P4 includes a figure showing a letter “D”, and a letter “D” shown below the figure. The fifth image P5 includes a figure showing a letter “E”, and a letter “E” shown below the figure. Each of the first image P1 through the fifth image P5 may be an icon, for example.

It is assumed that n is the number of images in the display region D1, and i is an integer from 1 to n. The multiple light sources 16 include the first light source group G1 to an n-th light source group Gn. An i-th light source group Gi is constituted by at least one light source 16 that overlaps an i-th image region Ai when observed from the normal direction of the display panel 12. When the illuminance is less than the first threshold Th1, the control circuit 20 allows the backlight 14 to turn on the i-th light source group Gi at a luminance that is higher as the illuminance is greater.

For example, with regard to the first image P1, dimming lighting of the eight light sources 16 of the first light source group G1 overlapping the first image region A1 is performed based on the illuminance. With regard to the second image P2, dimming lighting of the eight light sources 16 of the second light source group G2 overlapping the second image region A2 is performed based on the illuminance.

FIG. 9 shows a lighting state of the backlight 14, with multiple images superimposed thereon, when the illuminance of the incident light is greater than or equal to the first threshold Th1 and less than the second threshold Th2 in the second embodiment. In FIG. 9, the illustration of the image regions is omitted.

The multiple light sources 16 further include the first peripheral light source group OG1 to an n-th peripheral light source group OGn. An i-th peripheral light source group OGi is constituted by at least one light source 16 located on the periphery of the i-th light source group Gi. When the illuminance is greater than or equal to the first threshold Th1, the control circuit 20 allows the backlight 14 to turn on the i-th light source group Gi and at least one light source 16 of the i-th peripheral light source group OGi, at a luminance that is higher as the illuminance is greater. The at least one light source 16 of the i-th peripheral light source group OGi to be turned on in this case will be referred to as a first sub-light source group GAi.

It is assumed that j is an integer from 1 to n and different from i. Based on the positional relationship between an i-th image Pi and a j-th image Pj, the control circuit 20 determines a light source 16 to be turned on when the illuminance is greater than or equal to the first threshold Th1, among the light sources 16 included in the i-th peripheral light source group OGi and a j-th peripheral light source group OGj.

In specific, when the i-th image Pi is located near the j-th image Pj, the control circuit 20 determines turning on of the first sub-light source group GAi constituted by the light sources 16 located between the i-th light source group Gi and a j-th light source group Gj, in the i-th peripheral light source group OGi. When one row or one column of light sources 16 are located between the i-th light source group Gi and the j-th light source group Gj, it is defined as the i-th image Pi being located near the j-th image Pj. When each of the i-th light source group Gi and the j-th light source group Gj is constituted by a single light source 16 and when one light source 16 is located between the i-th light source group Gi and the j-th light source group Gj, it is defined as the i-th image Pi being located near the j-th image Pj. The i-th image Pi being located near the j-th image Pj may also be referred to as the i-th image Pi and the j-th image Pj being in proximity.

For example, since the first image P1 is located near the second image P2, dimming lighting of the first sub-light source group GA1, constituted by the four light sources 16 in one row located between the first light source group G1 and the second light source group G2, is performed.

That is, when the first image P1 is located near the left side of the second image P2, for example, the control circuit 20 determines turning on of the light sources 16 located to the right of the first light source group G1 in the first peripheral light source group OG1.

With this configuration, since the first sub-light source group GA1 being lit illuminates both the first image region A1 and the second image region A2, the light emitted from the first sub-light source group GA1 can be effectively used to increase the luminance of these image regions. For example, assuming that the light sources 16 located to the left of the first light source group G1 in the first peripheral light source group OG1 are turned on, the light from the light sources 16 substantially contributes only to the luminance of the first image region A1. Accordingly, turning on the first sub-light source group GA1 is more efficient. Therefore, while increasing the luminance of the two image regions in proximity, the increase in power consumption can be suppressed.

FIG. 10 shows a lighting state of the backlight 14, with multiple images superimposed thereon, when the illuminance of the incident light is greater than or equal to the second threshold Th2 in the second embodiment.

When the illuminance is greater than or equal to the second threshold Th2, the control circuit 20 allows the backlight 14 to turn on the i-th light source group Gi and the i-th peripheral light source group OGi at the maximum luminance. In the illustrated example, all light sources 16 are turned on. Since the multiple outermost light sources 16 are also turned on, the luminance near an edge of the image away from the first sub-light source group GAi, such as the left edge of the first image P1, is also increased.

When the illuminance is greater than or equal to the second threshold Th2, the control circuit 20 may allow the backlight 14 to turn on the i-th light source group Gi and the first sub-light source group GAi at the maximum luminance and may not allow the backlight 14 to turn on any other light source 16. In other words, as in FIG. 9, the multiple outermost light sources 16 may not be turned on. In this case, although the luminance near an edge of the image is somewhat lower than in the case of FIG. 10, power consumption can be reduced.

### Third Embodiment

The third embodiment differs from the first embodiment in that, when the illuminance is greater than or equal to the first threshold Th1, a light source 16 to be additionally turned on is determined based on the importance of the image. In the following, description will be given mainly for the differences from the first embodiment.

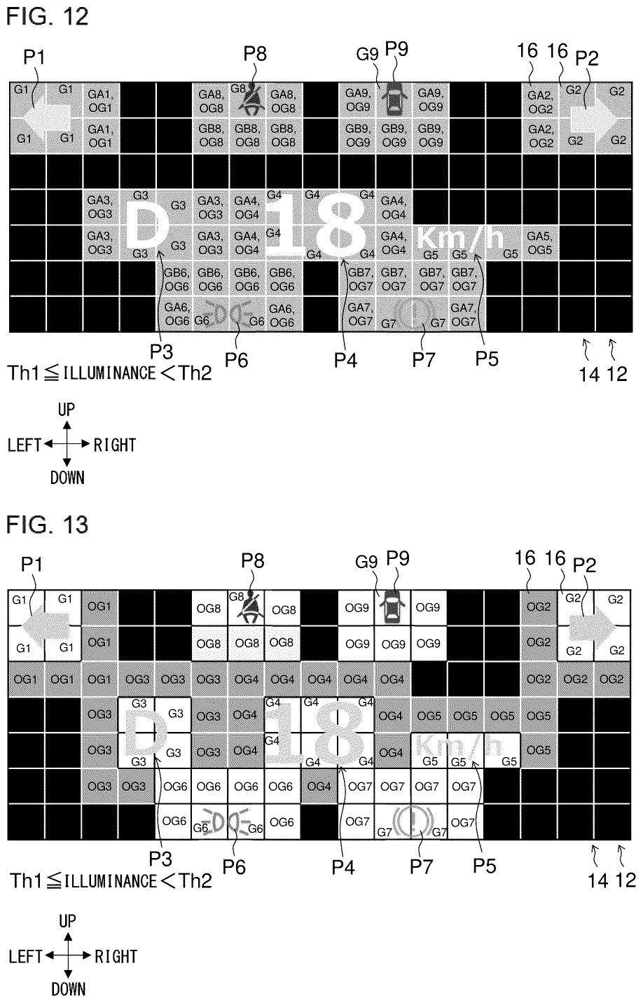

FIG. 11 shows a lighting state of the backlight 14, with multiple images superimposed thereon, when the illuminance of the incident light is less than the first threshold Th1 in the third embodiment. As an example, the display panel 12 is shown as a liquid crystal meter of a vehicle. In FIG. 11 and also in FIG. 12 and FIG. 13 described later, the number of light sources 16 is set to “119” as an example but is not limited to “119”.

The display panel 12 displays a first image P1 in a first image region A1, a second image P2 in a second image region A2, a third image P3 in a third image region A3, a fourth image P4 in a fourth image region A4, a fifth image P5 in a fifth image region A5, a sixth image P6 in a sixth image region A6, a seventh image P7 in a seventh image region A7, an eighth image P8 in an eighth image region A8, and a ninth image P9 in a ninth image region A9.

The first image P1 and the second image P2 show direction indicator lamps. The third image P3 shows a shift indicator. The fourth image P4 and the fifth image P5 show a speedometer. The sixth image P6 shows a lighting indicator lamp that indicates lighting of headlights, for example. The seventh image P7 shows a brake warning lamp indicating that the parking brake is operating. The eighth image P8 shows a seat belt warning lamp that warns of non-use of a seat belt. The ninth image P9 shows a door warning lamp that warns of a door being open. The brake warning lamp, seat belt warning lamp, and door warning lamp are also called tell-tales.

Each of the multiple images from the first image P1 to the ninth image P9 is assigned an importance level. The importance level may be expressed as “high” or “low” or may be indicated by a numerical value. When the importance level is expressed as “high” or “low”, a high importance level corresponds to an importance level greater than or equal to an importance threshold, and a low importance level corresponds to an importance level less than the importance threshold.

Here, the sixth image P6 for the lighting indicator lamp, the seventh image P7 for the brake warning lamp, the eighth image P8 for the seat belt warning lamp, and the ninth image P9 for the door warning lamp are assigned high importance levels. The first image P1, second image P2, third image P3, fourth image P4, and fifth image P5 are assigned low importance levels. The importance levels of the images for tell-tales should be suitably high, whereas the importance levels of the other images can be determined as appropriate.

In the following, the definitions of the i-th light source group Gi and the i-th peripheral light source group OGi are the same as in the second embodiment. When the illuminance is less than the first threshold Th1, regardless of the importance level of the i-th image Pi, the control circuit 20 allows the backlight 14 to turn on the i-th light source group Gi at a luminance that is higher as the illuminance is greater.

For example, with regard to the first image P1, dimming lighting of the four light sources 16 of the first light source group G1 is performed based on the illuminance. With regard to the eighth image P8, dimming lighting of the one light source 16 of the eighth light source group G8 is performed based on the illuminance.

FIG. 12 shows a lighting state of the backlight 14, with multiple images superimposed thereon, when the illuminance of the incident light is greater than or equal to the first threshold Th1 and less than the second threshold Th2 in the third embodiment. In FIG. 12 and FIG. 13, the illustration of the image regions is omitted.

The i-th peripheral light source group OGi includes the first sub-light source group GAi constituted by at least one light source 16, and a second sub-light source group GBi that is different from the first sub-light source group GAi and constituted by at least one light source 16. When the importance level of the i-th image Pi is less than the importance threshold and when the illuminance is greater than or equal to the first threshold, the control circuit 20 allows the backlight 14 to turn on the i-th light source group Gi and the first sub-light source group GAi at a luminance that is higher as the illuminance is greater. For example, the first sub-light source group GAi is constituted by multiple light sources 16 located adjacent, on the left and right, to a light source 16 of the i-th light source group Gi.

When the importance level of the i-th image Pi is greater than or equal to the importance threshold and when the illuminance is greater than or equal to the first threshold, the control circuit 20 allows the backlight 14 to turn on the i-th light source group Gi, the first sub-light source group GAi, and the second sub-light source group GBi, at a luminance that is higher as the illuminance is greater. For example, the second sub-light source group GBi is constituted by multiple light sources 16 located adjacent, above and below and diagonally, to a light source 16 of the i-th light source group Gi.

For example, with regard to the eighth image P8 having a high importance level, dimming lighting of the eighth light source group G8 and the eighth peripheral light source group OG8 is performed based on the illuminance. Meanwhile, with regard to the first image P1 having a low importance level, for example, dimming lighting of the first light source group G1 and the first sub-light source group GA1 is performed based on the illuminance.

With this configuration, when the illuminance is greater than or equal to the first threshold Th1 and when the importance level of the i-th image Pi is greater than or equal to the importance threshold, the luminance of the i-th image region Ai can be increased, compared to an image of which the importance level is less than the importance threshold. Therefore, even when the illuminance of the incident light is relatively high, the sixth image P6, seventh image P7, eighth image P8, and ninth image P9, which have higher importance levels, can be visually recognized more easily than images having lower importance levels. With regard to the images having lower importance levels, by not allowing the turning on of the second sub-light source group GBi located above, below, and diagonally to the i-th light source group Gi, the increase in power consumption by the display device 1 can be suppressed while improving visibility.

When the type, importance level, size, and display position of each image are set in advance, as in the liquid crystal meter of FIG. 11 and FIG. 12, light sources 16 to be turned on when the illuminance is greater than or equal to the first threshold Th1 may be set in advance, and the control circuit 20 may retain, in advance, information for identifying the light sources 16. On the other hand, when the type, importance level, size, and display position of each image are not determined in advance and are determined based on a video signal supplied to the control circuit 20, the control circuit 20 may determine the importance level of an image based on information on the importance level of the image included in the video signal.

### Modification of Third Embodiment

When the illuminance is greater than or equal to the first threshold Th1, luminance of a light source 16 to be additionally turned on may be determined based on the importance level of the image. In the following, description will be given mainly for the differences from the third embodiment.

FIG. 13 shows a lighting state of the backlight 14, with multiple images superimposed thereon, when the illuminance of the incident light is greater than or equal to the first threshold Th1 and less than the second threshold Th2 in a modification of the third embodiment.

When the importance level of the i-th image Pi is less than the importance threshold and when the illuminance is greater than or equal to the first threshold Th1, the control circuit 20 allows the backlight 14 to turn on the i-th light source group Gi at the maximum luminance and also turn on at least one light source 16 of the i-th peripheral light source group OGi at a luminance that is higher as the illuminance is greater.

When the importance level of the i-th image Pi is greater than or equal to the importance threshold and when the illuminance is greater than or equal to the first threshold Th1, the control circuit 20 allows the backlight 14 to turn on the i-th light source group Gi and at least one light source 16 of the i-th peripheral light source group OGi at the maximum luminance.

In the example of FIG. 13, when the illuminance is greater than or equal to the first threshold Th1, the control circuit 20 allows the backlight 14 to turn on the i-th light source group Gi and the i-th peripheral light source group OGi, regardless of the importance level of the i-th image Pi.

For example, with regard to the eighth image P8 having a high importance level, the eighth light source group G8 and the eighth peripheral light source group OG8 are turned on at the maximum luminance. Meanwhile, with regard to the first image P1 having a low importance level, for example, the first light source group G1 is turned on at the maximum luminance, and dimming lighting of the first peripheral light source group OG1 is performed based on the illuminance.

With this configuration, when the illuminance is greater than or equal to the first threshold Th1 and when the importance level of the i-th image Pi is greater than or equal to the importance threshold, the luminance of the i-th image region Ai can be increased, compared to the case where the importance level is less than the importance threshold. Therefore, even when the illuminance of the incident light is relatively high, the sixth image P6, seventh image P7, eighth image P8, and ninth image P9, which have higher importance levels, can be visually recognized easily.

### Fourth Embodiment

The fourth embodiment differs from the first embodiment in that, when the illuminance is greater than or equal to the first threshold Th1, a light source 16 to be additionally turned on is determined based on the size of the image. In the following, description will be given mainly for the differences from the first embodiment.

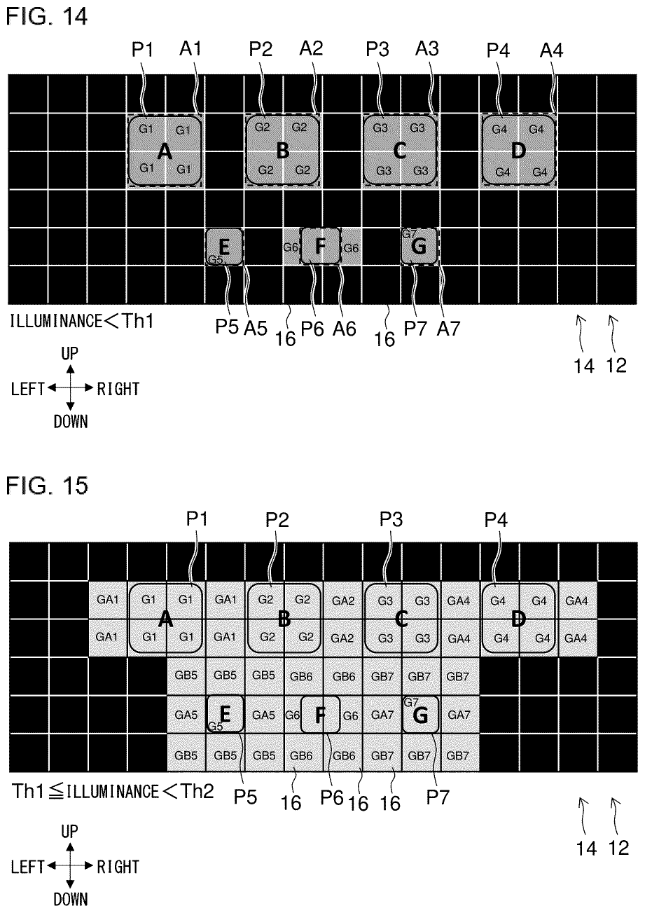

FIG. 14 shows a lighting state of the backlight 14, with multiple images superimposed thereon, when the illuminance of the incident light is less than the first threshold Th1 in the fourth embodiment. In FIG. 14 and also in FIG. 15 described later, the number of light sources 16 is set to “96” as an example but is not limited to “96”. In the example of FIG. 14, the display panel 12 displays the first image P1 to the seventh image P7.

The first image P1 shows a figure showing a letter “A”. The second image P2 shows a figure showing a letter “B”. The third image P3 shows a figure showing a letter “C”. The fourth image P4 shows a figure showing a letter “D”. The fifth image P5 shows a figure showing a letter “E”. The sixth image P6 shows a figure showing a letter “F”. The seventh image P7 shows a figure showing a letter “G”.

The size of each of the first image P1 through the fourth image P4 is greater than or equal to a size threshold. The size of each of the fifth image P5 through the seventh image P7 is less than the size threshold. The size of an image is equivalent to the size of the image region of the image. The size of an image can be represented, for example, by the number of light sources 16 that the image region overlaps. For example, the size of the first image P1 is “4”, and the size of the fifth image P5 is “1”. In the present embodiment, the size threshold may be “3”, for example.

In the following, the definitions of the i-th light source group Gi and the i-th peripheral light source group OGi are the same as in the second embodiment. Also, the definitions of the first sub-light source group GAi and the second sub-light source group GBi are the same as in the third embodiment. When the illuminance is less than the first threshold Th1, regardless of the size of the i-th image Pi, the control circuit 20 allows the backlight 14 to turn on the i-th light source group Gi at a luminance that is higher as the illuminance is greater.

For example, with regard to the first image P1, dimming lighting of the four light sources 16 of the first light source group G1 is performed based on the illuminance. With regard to the fifth image P5, dimming lighting of the one light source 16 of the fifth light source group G5 is performed based on the illuminance.

FIG. 15 shows a lighting state of the backlight 14, with multiple images superimposed thereon, when the illuminance of the incident light is greater than or equal to the first threshold Th1 and less than the second threshold Th2 in the fourth embodiment. In FIG. 15, the illustration of the image regions is omitted.

When the size of the i-th image Pi is greater than or equal to the size threshold and when the illuminance is greater than or equal to the first threshold Th1, the control circuit 20 allows the backlight 14 to turn on the i-th light source group Gi and the first sub-light source group GAi at a luminance that is higher as the illuminance is greater. For example, the first sub-light source group GAi is constituted by multiple light sources 16 located adjacent, on the left and right, to a light source 16 of the i-th light source group Gi.

When the size of the i-th image Pi is less than the size threshold and when the illuminance is greater than or equal to the first threshold Th1, the control circuit 20 allows the backlight 14 to turn on the i-th light source group Gi, the first sub-light source group GAi, and the second sub-light source group GBi, at a luminance that is higher as the illuminance is greater. For example, the second sub-light source group GBi is constituted by multiple light sources 16 located adjacent, above and below and diagonally, to a light source 16 of the i-th light source group Gi.

For example, with regard to the first image P1 of large size, dimming lighting of the four light sources 16 of the first light source group G1 and the four light sources 16 of the first sub-light source group GA1 is performed based on the illuminance. Since at least eight light sources 16 illuminate the first image P1, the luminance of the first image P1 can be increased.

Meanwhile, with regard to the fifth image P5 of small size, for example, dimming lighting of the one light source 16 of the fifth light source group G5, the two light sources 16 of the first sub-light source group GA5, and the six light sources 16 of the second sub-light source group GB5 is performed based on the illuminance. Since the nine light sources 16 illuminate the fifth image P5, the luminance of the fifth image P5 can be increased.

That is, with regard to the first image P1 of large size, compared to the fifth image P5 of small size, the number of light sources 16 of the first light source group G1 and the first sub-light source group GA1 is larger, so that equivalent luminance can be obtained even with a fewer number of light sources 16 to be additionally turned on.

With this configuration, when the size of the i-th image Pi is greater than or equal to the size threshold, only the first sub-light source group GAi, which is part of the i-th peripheral light source group OGi, is turned on. Therefore, while increasing the luminance of the i-th image region Ai, the increase in power consumption by the display device 1 can be suppressed.

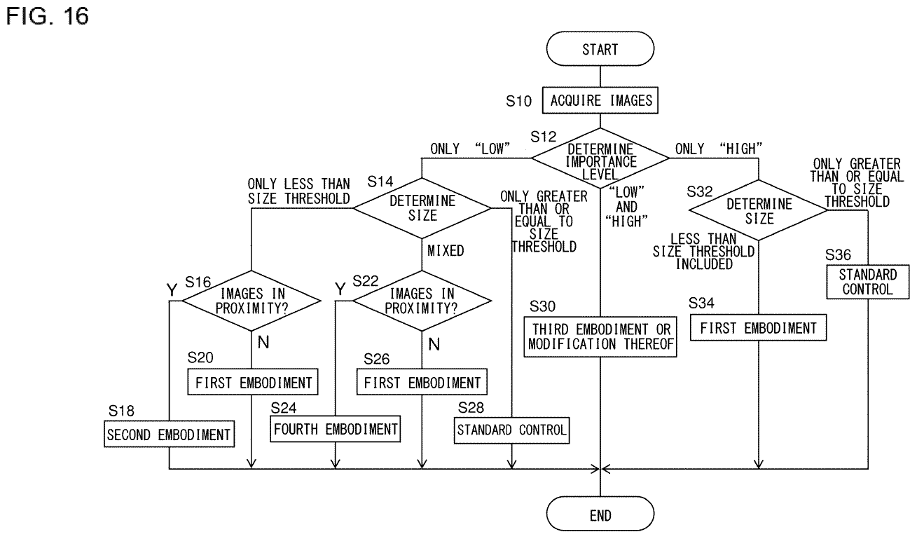

The first through fourth embodiments have been described above. Based on the importance level, size, and display position of the image to be displayed and according to the flowchart of FIG. 16 described below, which control of the first through fourth embodiments to perform may be determined.

When the importance level, size, and display position of the image are determined in advance, the designer of the display device 1 may determine the control according to the flowchart and design the control circuit 20 to perform the control thus determined. On the other hand, when the type, importance level, size, and display position of the image are not determined in advance and are determined based on a video signal supplied to the control circuit 20, the control circuit 20 may perform the following processing according to the flowchart based on the video signal.

FIG. 16 is a flowchart that shows an example of processing for determining control performed by the control circuit 20 shown in FIG. 1. In the following, an example in which the control circuit 20 performs processing is described. This processing is performed repeatedly.

The control circuit 20 acquires images based on a video signal (S10) and determines the importance level of each image (S12). When it is judged that only images with “low” importance levels are to be displayed, the control circuit 20 determines the size of each image (S14). When it is judged that only images of sizes less than the size threshold are to be displayed, the control circuit 20 judges whether the images are in proximity to each other (S16). When it is judged that the images are in proximity to each other (Y at S16), the control circuit 20 determines to perform the control of the second embodiment (S18) and terminates the processing. When it is judged at the step S16 that the images are not in proximity to each other (N at S16), the control circuit 20 determines to perform the control of the first embodiment (S20) and terminates the processing.

When it is judged at the step S14 that an image of size less than the size threshold and an image of size greater than or equal to the size threshold are mixed, the control circuit 20 judges whether the images are in proximity to each other (S22). When it is judged that the images are in proximity to each other (Y at S22), the control circuit 20 determines to perform the control of the fourth embodiment (S24) and terminates the processing. When it is judged at the step S22 that the images are not in proximity to each other (N at S22), the control circuit 20 determines to perform the control of the first embodiment (S26) and terminates the processing.

When it is judged at the step S14 that only images of sizes greater than or equal to the size threshold are to be displayed, the control circuit 20 determines to perform standard control (S28) and terminates the processing. The standard control means the control of performing dimming lighting of only the i-th light source group Gi constituted by a light source 16 overlapping the i-th image region Ai, based on the illuminance. It is assumed here, for example, that the size threshold is “9”, and when the size of an image is “3×3” or larger, the number of light sources 16 of the i-th light source group Gi is also “3×3” or larger. Accordingly, it is considered that, only by increasing the luminance of the light sources 16 of the i-th light source group Gi, the luminance of the i-th image region Ai is increased to a desired value.

When it is judged at S12 that an image with a “low” importance level and an image with a “high” importance level are mixed, the control circuit 20 determines to perform the control of the third embodiment or the modification thereof (S30) and terminates the processing. In this case, when the images are in proximity to each other, the control circuit 20 may combine the control of the second embodiment with the third embodiment or the modification thereof.

When it is judged at S12 that only images with “high” importance levels are to be displayed, the control circuit 20 determines the size of each image (S32). When it is judged that an image of size less than the size threshold is included, the control circuit 20 determines to perform the control of the first embodiment (S34) and terminates the processing. When it is judged that only images of sizes greater than or equal to the size threshold are to be displayed, the control circuit 20 determines to perform the standard control (S36) and terminates the processing.

The present disclosure has been described based on embodiments. The embodiments are intended to be illustrative only, and it will be obvious to those skilled in the art that various modifications to a combination of constituting elements or processes in the embodiments could be developed and that such modifications also fall within the scope of the present disclosure.

For example, the fourth embodiment may be combined with the second embodiment. In this case, when the i-th image Pi is located near the j-th image Pj, when the size of each of the i-th image Pi and the j-th image Pj is greater than or equal to the size threshold, and when the illuminance is greater than or equal to the first threshold Th1, the control circuit 20 allows the backlight 14 to turn on the i-th light source group Gi, and the first sub-light source group GAi constituted by a light source 16 located between the i-th light source group Gi and the j-th light source group Gj in the i-th peripheral light source group OGi. That is, in the example of FIG. 15, the two first sub-light source groups GA1 on the left side and the two first sub-light source groups GA4 on the right side are turned off. Also, the second, third, and fourth embodiments may be combined.

One embodiment of the present disclosure is as follows.

### [Item 1]

A display device, including:
a display panel that displays a first image in a first image region in a display region;
a backlight that is located behind the display panel and illuminates the display panel;
an illuminance sensor that detects illuminance of incident light; and
a control circuit that controls the backlight based on the illuminance,
wherein the backlight includes multiple light sources arranged in a matrix, and
wherein the control circuit:
   turns on a first light source group, which is constituted by at least one light source that overlaps the first image region when observed from a normal direction of the display panel, among the multiple light sources, when the illuminance is less than a first threshold, which is a predetermined value; and
   turns on the first light source group and at least one light source of a first peripheral light source group constituted by light sources located on the periphery of the first light source group, among the multiple light sources, when the illuminance is greater than or equal to the first threshold.

According to this embodiment, when the illuminance is greater than or equal to the first threshold, a light source located on the periphery of the first light source group is also turned on, in addition to the first light source group overlapping the first image region. Accordingly, compared to the case where only the first light source group is turned on, the luminance of the first image region can be increased.

### [Item 2]

The display device according to Item 1, wherein the control circuit:
turns on the first light source group at a luminance that is higher as the illuminance is greater and that is less than a predetermined luminance, when the illuminance is less than the first threshold; and
turns on the first light source group at the predetermined luminance when the illuminance is greater than or equal to the first threshold.

In this case, when the illuminance is less than the first threshold, the luminance of the first image region can be smoothly changed based on the illuminance.

### [Item 3]

The display device according to Item 1 or 2, wherein the control circuit turns on the at least one light source of the first peripheral light source group at a luminance that is higher as the illuminance is greater, when the illuminance is greater than or equal to the first threshold.

In this case, when the illuminance is greater than or equal to the first threshold, the luminance of the first image region can be smoothly changed based on the illuminance.

### [Item 4]

The display device according to any one of Items 1 through 3, wherein the control circuit:
turns on the first light source group and a first group, which is part of the first peripheral light source group, when the illuminance is greater than or equal to the first threshold and less than a second threshold, which is a predetermined value; and
turns on the first light source group, the first group, and a second group, which is part of the first peripheral light source group and different from the first group, when the illuminance is greater than or equal to the second threshold.

In this case, when the illuminance is greater than or equal to the first threshold, the luminance of the first image region can be smoothly changed.

### [Item 5]

The display device according to any one of Items 1 through 4, wherein the control circuit:
turns on the first light source group and a first sub-light source group, which is part of the first peripheral light source group, when an importance level of the first image is less than an importance threshold and when the illuminance is greater than or equal to the first threshold; and
turns on the first light source group, the first sub-light source group, and a second sub-light source group, which is part of the first peripheral light source group and different from the first sub-light source group, when the importance level of the first image is greater than or equal to the importance threshold and when the illuminance is greater than or equal to the first threshold.

In this case, when the illuminance is greater than or equal to the first threshold and when the importance level of the first image is greater than or equal to the importance threshold, the luminance of the first image region can be increased, compared to the case where the importance level is less than the importance threshold.

### [Item 6]

The display device according to any one of Items 1 through 4, wherein the control circuit:
turns on the first light source group at the maximum luminance and also turns on the at least one light source of the first peripheral light source group at a luminance that is higher as the illuminance is greater, when the importance level of the first image is less than the importance threshold and when the illuminance is greater than or equal to the first threshold; and
turns on the first light source group and the at least one light source of the first peripheral light source group at the maximum luminance, when the importance level of the first image is greater than or equal to the importance threshold and when the illuminance is greater than or equal to the first threshold.

In this case, when the illuminance is greater than or equal to the first threshold and when the importance level of the first image is greater than or equal to the importance threshold, the luminance of the first image region can be increased, compared to the case where the importance level is less than the importance threshold.

### [Item 7]

The display device according to any one of Items 1 through 4, wherein the control circuit:
turns on the first light source group and a first sub-light source group, which is part of the first peripheral light source group, when a size of the first image is greater than or equal to a size threshold and when the illuminance is greater than or equal to the first threshold; and
turns on the first light source group, the first sub-light source group, and a second sub-light source group, which is part of the first peripheral light source group and different from the first sub-light source group, when the size of the first image is less than the size threshold and when the illuminance is greater than or equal to the first threshold.

In this case, when the size of the first image is greater than or equal to the size threshold, while increasing the luminance of the first image region, the increase in power consumption can be suppressed.

### [Item 8]

The display device according to any one of Items 1 through 4,
wherein the display panel displays a second image in a second image region in the display region,
wherein the control circuit:
   turns on a second light source group, which is constituted by at least one light source that overlaps the second image region when observed from a normal direction of the display panel, among the multiple light sources, when the illuminance is less than the first threshold; and
   turns on the second light source group and at least one light source of a second peripheral light source group constituted by light sources located on the periphery of the second light source group, among the multiple light sources, when the illuminance is greater than or equal to the first threshold, and
wherein, based on a positional relationship between the first image and the second image, the control circuit determines a light source to be turned on when the illuminance is greater than or equal to the first threshold, among light sources included in the first peripheral light source group and the second peripheral light source group.

In this case, when the illuminance is greater than or equal to the first threshold, a light source can be turned on based on the positional relationship between the first image and the second image.

### [Item 9]

The display device according to Item 8, wherein, when the first image is located near the second image, the control circuit determines turning on of a light source located between the first light source group and the second light source group, in the first peripheral light source group.

In this case, while increasing the luminance of the first image region and the second image region, the increase in power consumption can be suppressed.

While various embodiments have been described herein above, it is to be appreciated that various changes in form and detail may be made without departing from the spirit and scope of the invention(s) presently or hereafter claimed.

### CROSS-REFERENCE TO RELATED APPLICATIONS

This application is a Continuation of International Application No. PCT/JP2023/011584, filed on Mar. 23, 2023, which in turn claims the benefit of Japanese Application No. 2022-102789, filed on Jun. 27, 2022, the disclosures of which Applications are incorporated by reference herein.

What is claimed is:

1. A display device, comprising:
a display panel that displays a first image in a first image region in a display region;
a backlight that is located behind the display panel and illuminates the display panel;
an illuminance sensor that detects illuminance of incident light; and
a control circuit that controls the backlight based on the illuminance,
wherein the backlight comprises a plurality of light sources arranged in a matrix,
wherein the plurality of light sources include a first light source group constituted by at least one light source that overlaps the first image region when observed from a normal direction of the display panel, and a first peripheral light source group constituted by at least one light source located on the periphery of the first light source group, and
wherein the control circuit:
allows the backlight to turn on the first light source group when the illuminance is less than a first threshold, which is a predetermined value; and
allows the backlight to turn on the first light source group and at least one light source of the first peripheral light source group, when the illuminance is greater than or equal to the first threshold.

2. The display device according to claim 1, wherein the control circuit:
allows the backlight to turn on the first light source group at a luminance that is higher as the illuminance is greater and that is less than a predetermined luminance, when the illuminance is less than the first threshold; and
allows the backlight to turn on the first light source group at the predetermined luminance when the illuminance is greater than or equal to the first threshold.

3. The display device according to claim 1, wherein the control circuit allows the backlight to turn on the at least one light source of the first peripheral light source group at a luminance that is higher as the illuminance is greater, when the illuminance is greater than or equal to the first threshold.

4. The display device according to claim 1,
wherein the first peripheral light source group comprises a first group constituted by at least one light source, and a second group that is different from the first group and constituted by at least one light source, and
wherein the control circuit:
allows the backlight to turn on the first light source group and the first group, when the illuminance is greater than or equal to the first threshold and less than a second threshold, which is a predetermined value; and
allows the backlight to turn on the first light source group, the first group, and the second group, when the illuminance is greater than or equal to the second threshold.

5. The display device according to claim 1,
wherein the first peripheral light source group comprises a first sub-light source group constituted by at least one light source, and a second sub-light source group that is different from the first sub-light source group and constituted by at least one light source, and
wherein the control circuit:
allows the backlight to turn on the first light source group and the first sub-light source group, when an importance level of the first image is less than an importance threshold and when the illuminance is greater than or equal to the first threshold; and
allows the backlight to turn on the first light source group, the first sub-light source group, and the second sub-light source group, when the importance level of the first image is greater than or equal to the importance threshold and when the illuminance is greater than or equal to the first threshold.

6. The display device according to claim 1, wherein the control circuit:
allows the backlight to turn on the first light source group at the maximum luminance and also turn on the at least one light source of the first peripheral light source group at a luminance that is higher as the illuminance is greater, when the importance level of the first image is less than the importance threshold and when the illuminance is greater than or equal to the first threshold; and
allows the backlight to turn on the first light source group and the at least one light source of the first peripheral light source group at the maximum luminance, when the importance level of the first image is greater than or equal to the importance threshold and when the illuminance is greater than or equal to the first threshold.

7. The display device according to claim 1,
wherein the first peripheral light source group comprises a first sub-light source group constituted by at least one light source, and a second sub-light source group that is different from the first sub-light source group and constituted by at least one light source, and
wherein the control circuit:
allows the backlight to turn on the first light source group and the first sub-light source group, when a size of the first image is greater than or equal to a size threshold and when the illuminance is greater than or equal to the first threshold; and
allows the backlight to turn on the first light source group, the first sub-light source group, and the second sub-light source group, when the size of the first image is less than the size threshold and when the illuminance is greater than or equal to the first threshold.

8. The display device according to claim 1,
wherein the display panel displays a second image in a second image region in the display region,
wherein the plurality of light sources include a second light source group constituted by at least one light source that overlaps the second image region when observed from a normal direction of the display panel, and a second peripheral light source group constituted by at least one light source located on the periphery of the second light source group,
wherein the control circuit:
allows the backlight to turn on the second light source group when the illuminance is less than the first threshold; and
allows the backlight to turn on the second light source group and at least one light source of the second peripheral light source group, when the illuminance is greater than or equal to the first threshold, and
wherein, based on a positional relationship between the first image and the second image, the control circuit determines a light source to be turned on when the illuminance is greater than or equal to the first threshold, among light sources included in the first peripheral light source group and the second peripheral light source group.

9. The display device according to claim 8, wherein, when the first image is located near the second image, the control circuit determines turning on of a light source located between the first light source group and the second light source group, in the first peripheral light source group.

10. The display device according to claim 1, wherein the entirety of the first peripheral light source group does not overlap the first image region when observed from a normal direction of the display panel.

11. The display device according to claim 1, wherein the control circuit:
allows the backlight to turn on the first light source group at the maximum luminance when the illuminance is less than the first threshold; and
allows the backlight to turn on each of the first light source group and at least one light source of the first peripheral light source group at the maximum luminance, when the illuminance is greater than or equal to the first threshold.

12. The display device according to claim 1, wherein, when the illuminance is less than the first threshold, the control circuit allows the backlight to turn off a light source other than the first light source group.

13. The display device according to claim 1, wherein, when viewed from an observer's side, the illuminance sensor is disposed next to the display panel.
